(19) United States
(12) Patent Application Publication
(10) Pub. No.: US 2009/0147523 A1
(43) Pub. Date: Jun. 11, 2009

(54) Versatile light system

(76) Inventor: Leif eric tobias Levon, Alta (SE)

Correspondence Address: LEIF LEVON, ALMVAGEN 7.5 tr, ALTA, STOCKHOLM, 13830, SE

(21) Appl. No.: 12/288,409

(22) Filed: Oct. 21, 2008

(30) Foreign Application Priority Data
Dec. 6, 2007 (SE) 0702749-3
Feb. 13, 2008 (GB) 0802632.0
Jul. 31, 2008 (GB) 0813946.1

(51) Int. Cl. F21V 13/02; F21V 7/00; F21V 7/06

(52) U.S. Cl. 362/296.01; 362/341; 362/350; 362/343

(57) ABSTRACT

A versatile reflector light system able to utilize ambient light in order to increase illumination in a decorative or useful manner, on behalf of it's own appearance, or in combination with ornaments as well as function as specially lit reflectors for pedestrians and motorists. Modified versions may be powered by induction methods in order to create motion and additional light.

### CROSS-REFERENCE TO RELATED APPLICATIONS

This application for a utility patent claims the benefit of Swedish patent application No. 0702749-3 filed Dec. 12, 2007, including UK patent application numbers GB0802632.0 filed Feb. 14, 2008 and GB0813946.1 filed Jul. 31, 2008.

### FIELD OF INVENTION

This invention relates generally to energy saving light systems able to effectively use fluorescent or luminescent substances in conjunction with reflectors, prisms and/or lenses to respond to surrounding light or other energy sources in order to fluoresce or luminesce and emit light of various wavelengths, as well as operate in combination with other illumination systems, enabling constant production of light or glow, irrespective of external prevailing dark or light environmental conditions.

### BACKGROUND OF THE INVENTION

Methods to enhance attractiveness of ornaments and ensure increased safety for pedestrians and motorists using light and motion, in an environment friendly energy saving way, receiving power from remote energy sources.

Ornaments become more appealing by making them motile and/or glow. Likewise traffic cones or warning posts become more visible when combining a visible light source, and help to alert or draw attention to certain dangers such as road barriers.

A common method used is to add a light source powered by small electro-chemical cells to certain sections or parts of an item.

However, this method is only temporary in nature, since the active life of these batteries are short lived and soon require replacement.

One method to overcome this problem is to use rechargeble batteries or solar panels. These methods only solve part of the problem, since batteries are often cumbersome to replace, add weight and space of the article under consideration, and solar panels occupy vast surface areas relative to that provided by its host appliance.

Utilizing ambient light, sunlight and induction techniques in suitable fashion will solve all these problems. The versatile light system aims to combine different technologies in order to both save electric energy, as well as to promote safety and act as a decorative device in it's own right or as part of other objects.

Massive objects can receive and transmit light from one end to the other, as well as via their sides, and then further convey their rays along their length until finally terminating at their terminal ends.

Instead of received light crossing/traversing a cylindrical lens or rod, it may, due to properties of the material, especially uranium glass or plastic, spread the rays lengthwise along the structure, by internal reflection, tending to transcend towards its external ends. Other body shapes and properties may allow the entire structure to glow. For example multi-faceted symmetrical or asymmetrical objects may exhibit enhanced light receiving and transmitting properties.

These facets may be in the shape of multiple plane surfaces or small dome shaped surfaces acting as small lenses. Other examples may simply appear as honey comb shaped, resembling a bunch of grapes, or more complex forms such as compound eyes similar to that seen in certain insect species. Multi-faceted configurations provide an increased surface area for receiving and transmitting light/radiant energy, and promote further photon excitation and luminescent ability.

This property of solid materials, to absorb and distribute light, may be used to collect ambient and other light rays to make ornaments appear to illuminate more than normal, and appear beautiful to an onlooker.

This phenomenon is not restricted to solids, but may occur in other forms such as liquids, gels and gases.

Combining light guide technology and configuring reflectors to collect and concentrate light onto and into solid objects, as well as utilizing a plurality of lenses and or prisms or crystals, at or near areas where light is distributed or received, will create powerful enhanced illumination improvements, as opposed to whether they were not employed. Working in tandem this symbiotic relationship can even reduce the demand for batteries in certain collectibles, gifts, toys or a variety of other items. In effect the materials' properties of being able to act as light receivers and transmitters simultaneously provides a form of preserving energy.

For example ornamental crystals or decorative glass objects may appear to be internally lit, when in fact they are only utilizing ambient or indirect light, in order for them to glow brightly.

Luminescent objects may be symmetrical or asymmetrical, of variable size and shape, positioned in such a way as to maximize the amount of light received along their body structure, in order to further conduct/convey/transmit to as well as from their distal ends or entire body structure. Materials which promote photon activity, such as vaseline/uranium/plutonium/fluorescent/biological hybrids, inorganic or organic substances may be added.

Internally or partly internally mounted light receiving/transmitting/conducting objects may be made of any material or substance able to absorb photons by means of electromagnetic radiation such as light or other methods promoting excitation of photons to a higher energy state as well as able to emit photons.

There are an abundance of materials which when influenced by an energy source excite electrons and produce light. Many are called fluorescent, luminescence, photoluminescent, bioluminescence, phosphorescent and some are simply called day-glo or neon colours, and contain pigments and minerals. Coumarin for example Coumarin6 is an example of an effective fluorescent daylight pigment dye. Electro-luminescents or fluorescents can also be excited/activated using induction techniques, such as induced currents, microwaves, high energy transference, or photovoltaic means. Indeed any system which emits light when bombarded by radiation may be employed or chemicals which absorb ultraviolet light and release visible light as energy.

### PRIOR ART

Examples of noted prior art may be exemplified by:

U.S. Pat. No. 2007091635, showing a lens collecting ambient light from outside an electronic device to illuminate an internal display surface.

GB2240616 relates to a light receiving reflector lacking a posterior aperture with a spaced relation to a centrally placed light absorbing body.

GB5934782 exemplifies a light guide apparatus composed of a translucent plate in conjunction with light pipes and converging facets directed toward a catchment area.

U.S. Pat. No. 5,092,809 illustrating a pinwheel toy having iridescent blade tips containing fluorescent dye.

U.S. Pat. No. 4,655,721 depicting luminescent material in conjunction with a toy doll.

U.S. Patent Application Publication 2002/0065019 A1, demonstrating a novelty toy wand and claims that a second end is internally mirrored.

G.B1473690 describing a light distributing unit consisting of flat sheets or rods whose end surfaces emit light in response to general illumination of the main surfaces by daylight.

The invention includes U-shaped rods projecting through apertures, but no apertures hosted by reflectors, and describes reflectors only as receivers of light emanating from each end of tips of rods or ends of plastic sheets, and specifies further in claim #10 that there is a spaced relation to the terminal surface of the fluorescent plastics member, and confirmed by their accompanying drawings.

The previous prior art does not either include other important enhancing luminescent techniques, such as rear light collectors and concentrators in the form of posteriorly situated reflectors or even lenses or prisms gathering light from behind the luminous material.

Hence, all of the above mentioned inventions emit a very weak light compared to rods, sheets or objects of any other shape and configuration made from light receiving/transmitting/conducting/luminescent materials that are specifically internally or partly internally mounted into reflectors that collect and reflect light rays anteriorly as well as posteriorly.

Reflectors promote photon pump activity by effectively acting as light collectors and provide more concentrated light to the luminescent material, while simultaneously allowing the reflective surfaces to act as both receivers and transmitters of light, delivering a powerful continuous two way flow of radiant energy or constant chain reaction.

Thus, the efficiency or number of Lux or Lumen/Luminous flux/Candela increases when the material receives light from the front of the reflector as well as the exposed portion protruding through the reflectors rear aperture.

Luminosity may also be enhanced by compressing luminescent material or housing luminescent dyes and particles in a pressurized translucent compartment. While certain fluorescent particles will react favourably in a vacuum or among noble gases. Light of certain wavelengths will also alter the sensation of brightness, and is influenced by the reflecting and refracting material and medium surrounding the illuminated object. Other light enhancing techniques may be in the form of multiple luminescent bodies such as several spherical objects, bundles of rods, layers of sheets, several pyramidal/conical objects or a variety of symmetrical or asymmetrical shapes.

Fluorescent dyes may be further divided into primary colours such as green, red and blue/violet. Combining sets of primary colours may provide a whiter stronger light. The greatest efficiency is achieve if sun light or ultra violet light is allowed to collect and internally reflect rays from an additional posteriorly situated light guiding reflector or surrounding reflecting collar accompanied by lenses and/or prisms surrounding the dorsal part of the internally mounted fluorescing or luminescing material. In fact the light intensity or efficiency may even surpass a variety of conventional battery operated diode lamps or incandescent light bulbs, and may therefore substitute these for this more environment friendly system, as well as contribute to a reduction in the ever mounting waste of resources such as manufacturing and disposing of electrochemical cells and might be regarded as a new energy source or alternative form of energy to power certain kinds of lamps, resulting in reduced green-house gases.

The versatile light system also has the objective of being durable, long lasting, lighter than conventional systems and have a relatively low or negligible heat dissipation rate. Since a versatile light system is able to work without batteries or large solar panels the unit may appear relatively light weight and non fragile. It may also act as a very mobile untethered versatile light system.

Traditional solar garden lamps are only lit during darkness since they require recharging during sun lit hours. Since the versatile light system is able to shine during day light and is not dependant on batteries it may be combined with a traditional solar powered lamp and so by secure a 24 hour illumination device.

The versatile light system operates according to the following main principles: An object may be placed near or in a reflector. The reflector will collect and reflect light onto the object, and the object in turn will receive and transmit light onto the reflectors surface.

The end result is that both the reflector and the object emit light to an observer. A reflector may have an aperture through which a tail section or hind portion of a body protrudes in order to receive additional external light. This terminal portion may both receive light from the rear region as well as that stemming from its main body section lodged in the anterior compartment. Since the posterior section may also appear to glow it may be used in a decorative or functional manner. This can be achieved by applying lenses or prisms near or on it's surface.

Additionally, a reflector or reflectors may envelope it's area in order to both project light onto the bodies end piece as well as reflect light issuing from it.

When two reflectors are set up in this manner, their rear convex surfaces face one another and their apertures merge in order for the light receiving/transmitting body to appear on either side of their concave surfaces.

A small gap between their convex surfaces will ensure light to reflect between these surfaces and reach an exposed portion of the light receiving/transmitting body. This method is especially useful for earrings or wall ornaments, since an opposing side will be physically or structurally blocked and hindered from receiving radiant energy.

A similar arrangement can be employed using pyramidal, conical or oblong reflectors Versatile light systems may be provided with their own internal light source powered by induction,by transferring energy wirelessly from a distantly placed primary coil to a secondary coil housed in or near one of the reflectors.

Most reflectors project light outwardly convergently, divergently or in a collimated fashion.

However, some reflectors may work in reverse order, acting as a light guide and reflecting inwardly. That is light rays are internally reflected toward the reflectors rear converging base aperture instead of forward. As the circumference or radius of the reflector diminishes the light tends to concentrate in the confined space. This is especially beneficial when the main objective is to concentrate light onto an internally mounted or partly placed light receiving/transmitting body.

Creating motion of decorative ornaments or sign posts is another important visual stimulant and function. The ability to change direction of a light source is necessary for a number of reasons. Movement will allow tracking of a light source in order to maintain maximum supply of radiant energy, as well as face a particular direction in order to enter a particular field of view.

Movement can occur mechanically, electromagnetically, magnetically, or by external forces such as air/water pressure fluctuations, temperature changes or wind currents. One or more magnets suitably mounted on or under the ornament, mutually engaged by distant magnetic forces for example a levitator or other magnetic actuator, can be made to move or even levitate reducing undesirable frictional forces and appear novel. Other inductive forces may of course also be employed.

Energy saving methods would involve winding up a spring driving a metronome, egg timer or clock. For side to side movements a magnet may be affixed to the metronome's pendulum and the apparatus positioned below or to the side of an ornament accompanied by a magnet. For circular movements an egg timer carrying a magnet may be used. Even a solar powered rotating flower pot stand modified for carrying magnets will cause indirect movement.

The versatile light system may be made to blink by covering sections with sheets containing crystals or polarizing particles which respond to slight energy fields, becoming intermittently translucent, and regulated by currents from secondary coils receiving energy from distant primary coils or small photo voltaic solar cells. The light receiving/transmitting/conducting/fluorescent material may be in solid, liquid or gas form, and may be charged and excited by distantly placed energy sources such as ultra violet light, laser, infrared, microwaves and all other types of electromagnetic radiation as well as influenced by external electromotive forces. Although shape or form of reflectors does influence reflective as well as collective abilities, any design may be used in combination with suitably placed fluorescent or luminescent material, and is generally not restricted to any particular reflective angle. Special effects may of course be achieved when altering reflective angles. In some cases when directing concentrated light toward a tapered end of a light collecting reflector, a reflective angle of between 40 and 0 degrees may be desirable. Concave and parabolic shapes on the other hand tend to concentrate light more centrally in the front region, and may be influenced by Fresnell, hologram, laser grooved or multifaceted reflective surfaces. Rays may also be redirected from reaching a parabolic mirror's focal point by including a smaller supplementary reflector having their concave surfaces face one another, enabling collimated rays to reach the light receiving/emitting material.

The invention will now be described by referring to the accompanying drawings:

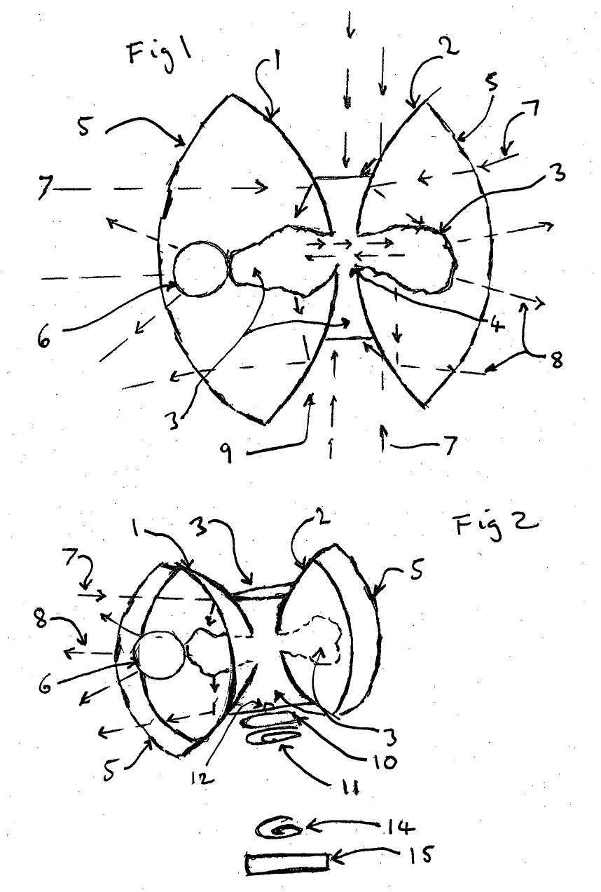

FIG. 1 Shows a cross section of two reflectors back to back, each capable of receiving and transmitting light to and from light conducting and transmitting material adjoining the reflectors at their base apertures.

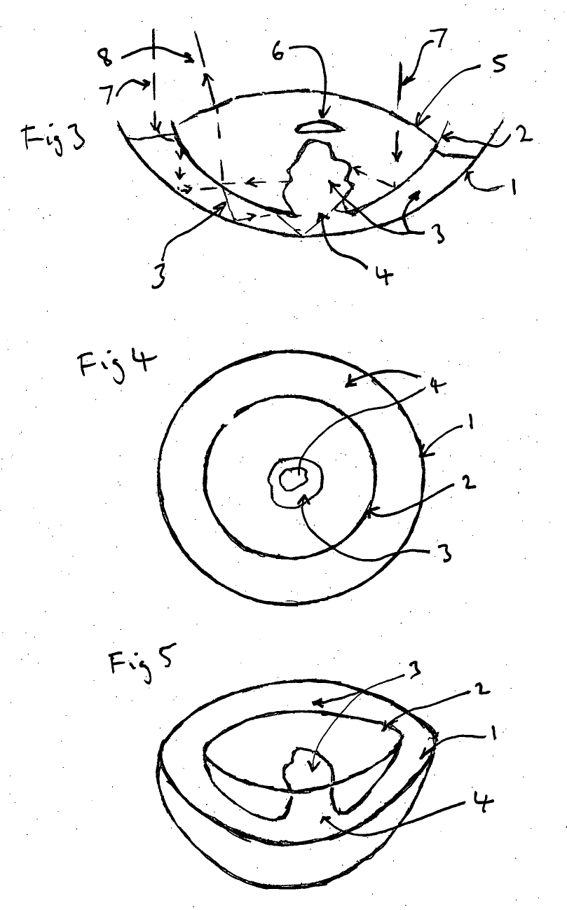

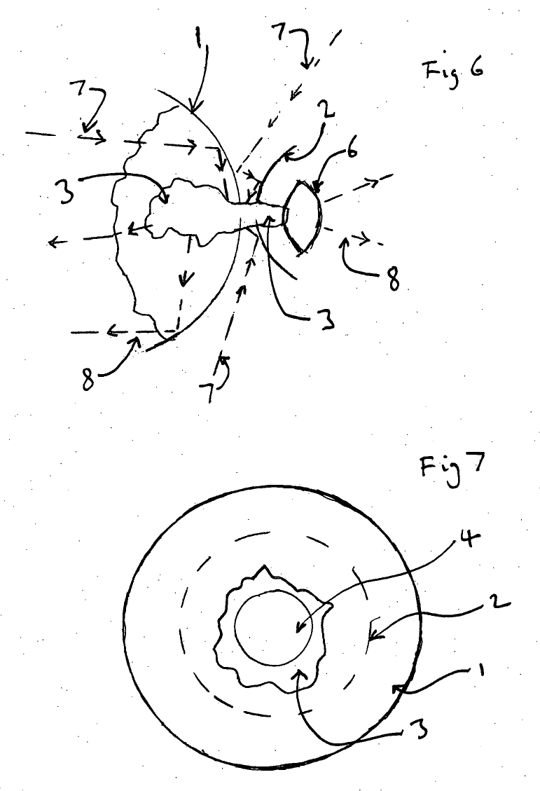

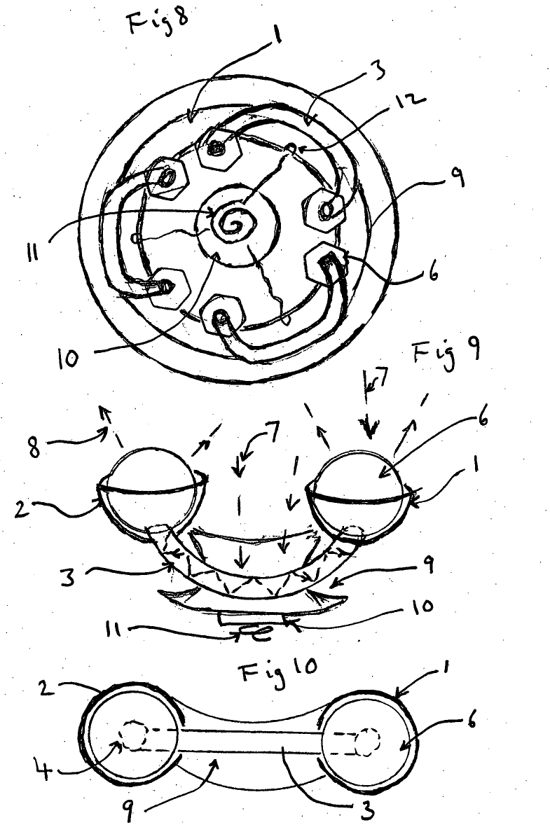

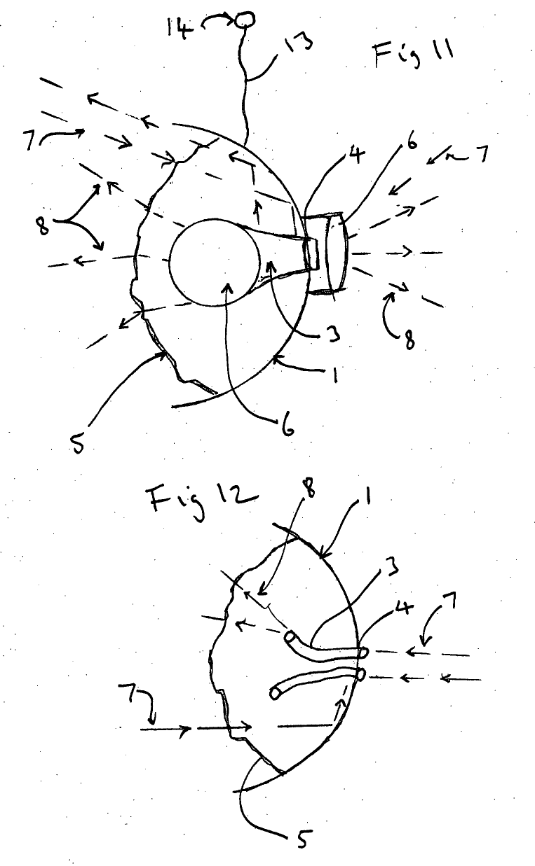

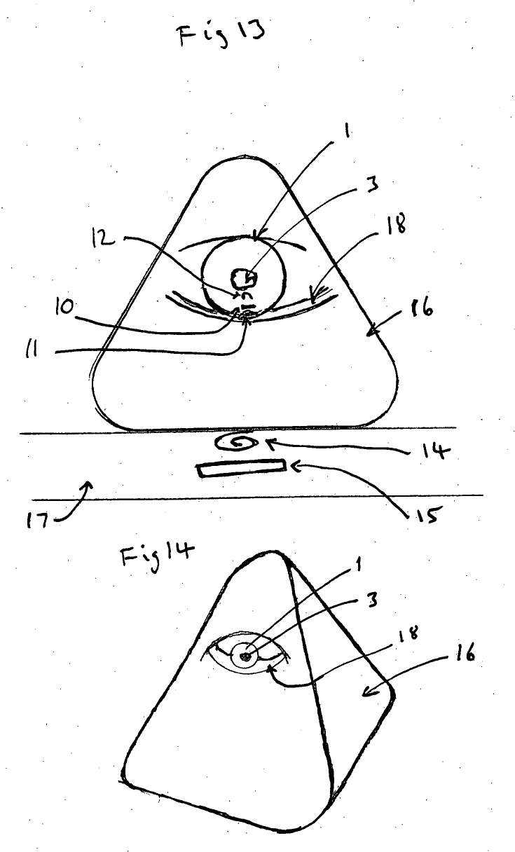

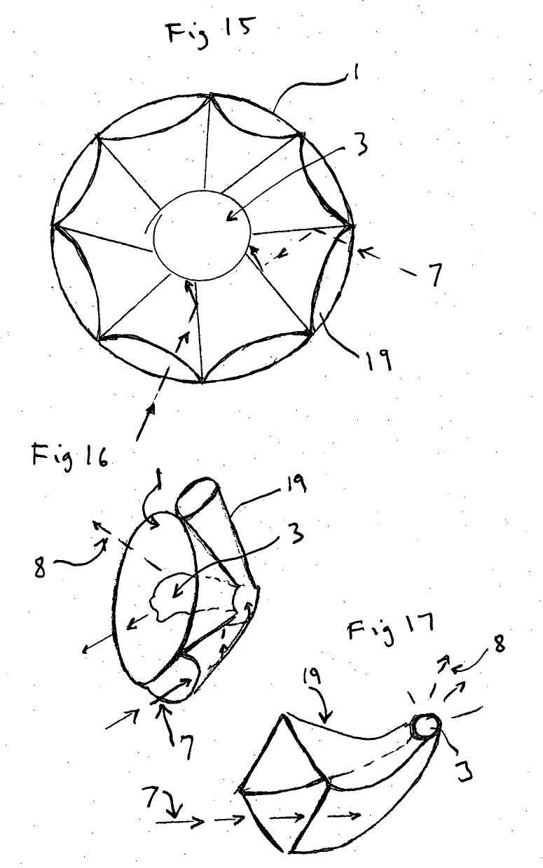

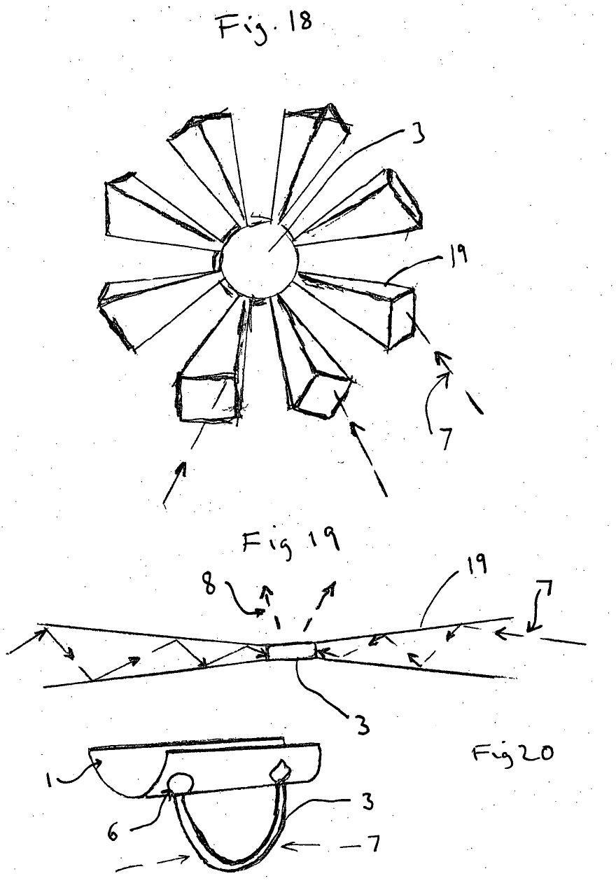

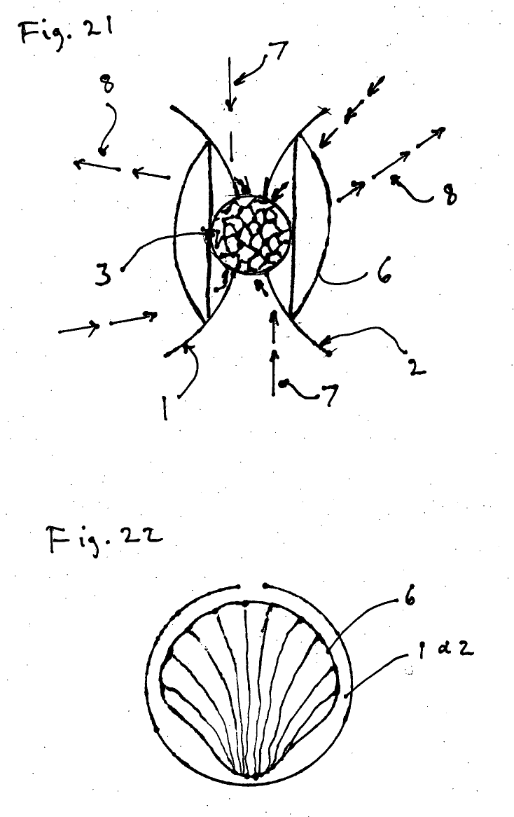

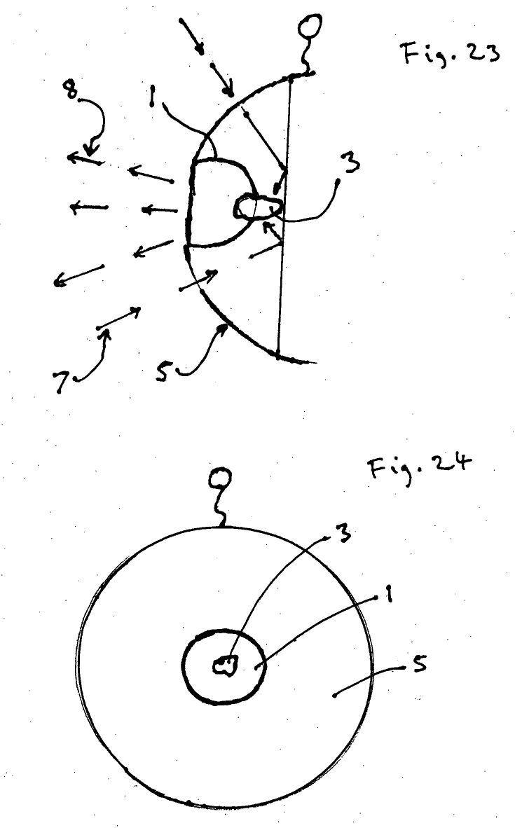

FIG. 2. Shows a schematic perspective of FIG. 2, including a diode for additional light, powered by a secondary coil, receiving energy via a primary coil placed some distance away, and a magnet influenced by surrounding magnets, in order to create motion or levitational effects.

FIG. 3 Illustrates cross section of a convex reflector placed inside a concave reflector, with their reflective gap partly or completely filled with light conducting and emitting material, where part of this material protrudes from the base aperture of the smaller reflector.

FIG. 4 Depicts FIG. 3 as seen from above.

FIG. 5 Shows a perspective view of FIGS. 3 and 4.

FIG. 6 Portrays a modified version of FIG. 1. with one large and one small reflector joined by a small bridge, between their rear apertures, of light conducting and light emitting material, partly filling the void of the large reflector as well as occupying a central area of the small reflector.

FIG. 7 Shows a top view of FIG. 6.

FIG. 8 Shows curved optical rods sunk in-between circular reflective depressions. The tips of rods project up and out of the mirror like opening, and enter reflectors housed by spherical lenses. A secondary coil and a magnet are visible in the middle of the drawing.

FIG. 9 Shows a side view of one of the optical sets mounted in circular formation in FIG. 8.

FIG. 10 Shows FIG. 9 as it would appear from above.

FIG. 11 Shows a simplified version of the invention, consisting of only one reflector, but still able to collect and receive light from the front and the rear.

FIG. 12 Shows a very basic model of the invention, where one reflector houses optical strands or fibres.

FIG. 13 Shows a front view of the invention placed on a small guide track to provide variable motion when activated by a distant magnet, as well as illuminate in the dark aided by one or more diodes connected to a secondary coil powered by a concealed primary coil.

FIG. 14 Shows a perspective view of FIG. 13.

FIG. 15 Shows the combined use of a reflector receiving light from specially adapted conical or pyramidal light guide reflectors.

FIG. 16 is a perspective view of a FIG. 15.

FIG. 17. shows an example of a pyramidal reflector tailor made for the versatile light system.

FIG. 18 Shows how conical and pyramidal reflectors may work independently from standard reflectors i.e. those that reflect outwardly.

FIG. 19 shows a cross section of pyramidal or conical reflectors as used in FIG. 18.

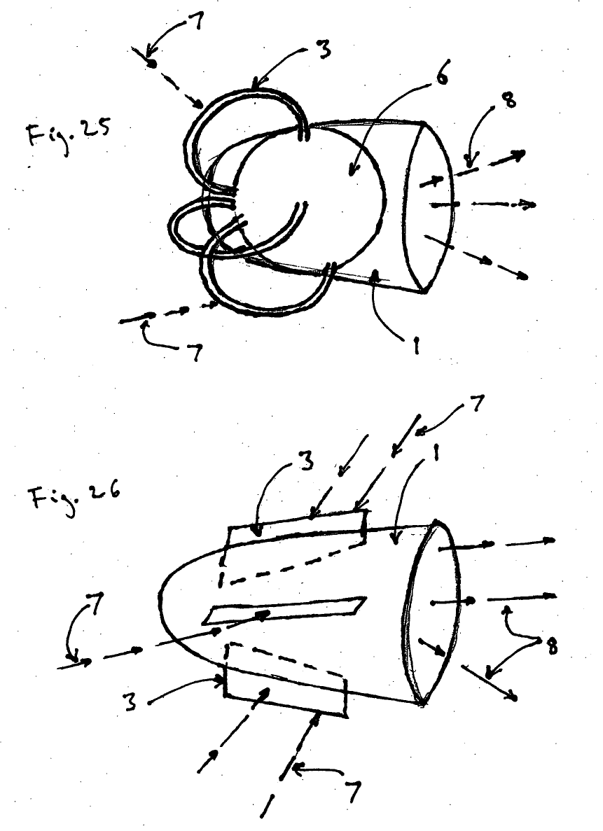

FIG. 20 shows a curved light conducting rod emitting light to an oblong reflector or vice versa.

FIG. 21 illustrates a symmetrically shaped versatile light system reflector arrangement housing a multifaceted fluorescent optic body.

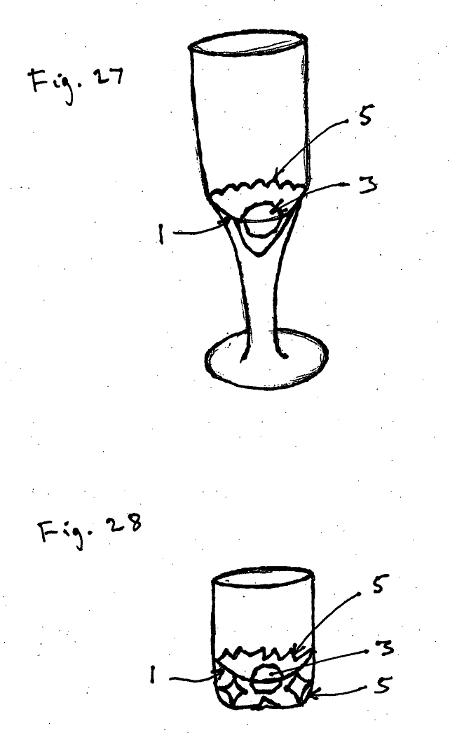

FIG. 22 depicts a thick prismatic lens in the form of a sea shell as it would appear on ornament, demonstrating the characteristic troughs and furrows accommodating lens 6.

FIG. 23 shows a side view of a circular wall ornament having a transparent bowl shaped prismatic surface 5. The tapered portion of the bowl has been provided with a reflector ornament 1 in order to distribute light from this section. A flat mirror covers the large aperture of the bowl and has its reflective surface directed towards the reflectors fluorescent material 3, in order to direct incoming ambient light 7 from the bowls sides onto said illuminator.

FIG. 24 shows a front view of of FIG. 23. Reflector 1 houses luminous material 3, and faces a viewer, and is covered by a bowl shaped prismatic face 5. A tether and hook have also been provided to hang the ornament securely on a wall preferentially near a window.

FIG. 25 Shows a bell shaped versatile reflector ornament. Looped illuminated luminescent rods or strands 3 have their first tail ends piercing apertures confined to a central rear area of the reflector 1 and arch in such a way as to join with their second terminal ends into various other apertures along the body of the reflector, thereby providing internal illumination. Part of the cavernous area of the reflector has a refracting body 6. The refracting body may contain an attractive figure centrally embedded within its structure,and may receive light from behind as well as from the sides. A spectator will notice how the light 8 shifts from side to side as he/she moves the reflector ornament.

FIG. 26 Shows a variant of FIG. 25. Sheets or fins 3 have replaced rods, and slit like apertures have been constructed along the course of the reflectors body structure 1 in order for them to deliver a pleasant variable light effect 8. Modified versions may have looped sheets going from one aperture to another as in FIG. 25, and the slit like apertures may be straight, zig-zag, curved or irregular.

FIG. 27 Depicts a wine glass with an internally mounted reflector ornament so that the fluorescent optic body 3 protrudes into a distal depression at the stem/shaft end region where it merges with the base of the receptacle. The thickness and shape of the translucent stem acts as a light receiving/transmitting device as well as concentrates rays of light onto the projecting fluorescent body 3, partly housed in the stem section and partly mounted in the reflector surfaces of reflector 1. When subjects lift the glass and simultaneously tilt it, a nice glow will appear from within the container vessel. This light show can become more artistic if the beakers' walls are lined with highly reflective material such as gold or silver.

FIG. 28 Shows a perspective view of a drinking glass in a similar set up to that exemplified in FIG. 27, but here the stem has been replaced by a thick prismatic lens 5 in the shape of a glass base/foot. Reflector 1 utilises its accompanying magnet or magnets in order to levitate and rotate, when influenced by suitable external magnetic forces, creating moving light and adding new dimensions to the visual display.

The central trough reflector formed between two opposing convex surfaces of reflector 1 and 2, not shown here, may also be utilised in a decorative manner by surrounding the area with a prismatic face or frost-like surface.

FIG. 29 Shows a side view of two twin reflectors using an alternative power source to provide intense light. This particular configuration allows light to travel from distally placed diode lamps through a light guide system composed of internally reflecting tapering cones or pyramids 2b. Light is projected towards an exposed area of luminescent material 3 lodged between reflector 1 and 2. A light base may be provided which operates by means of induction or from a mains supply unit.

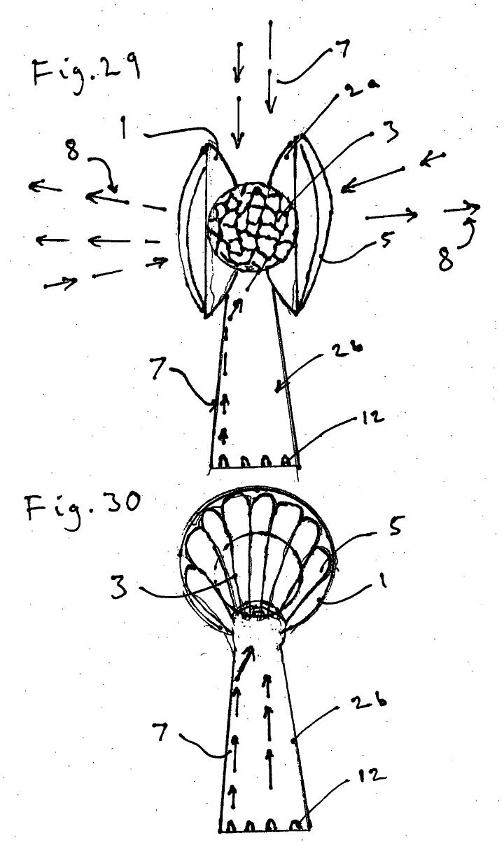

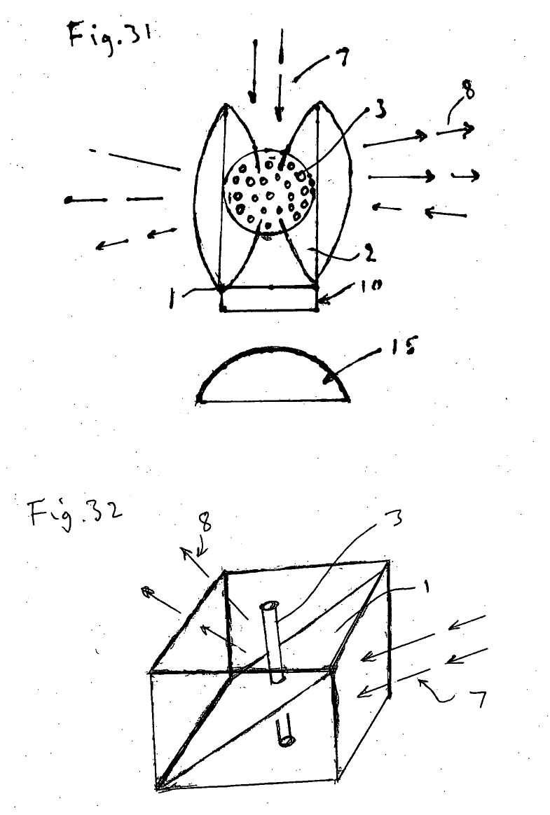

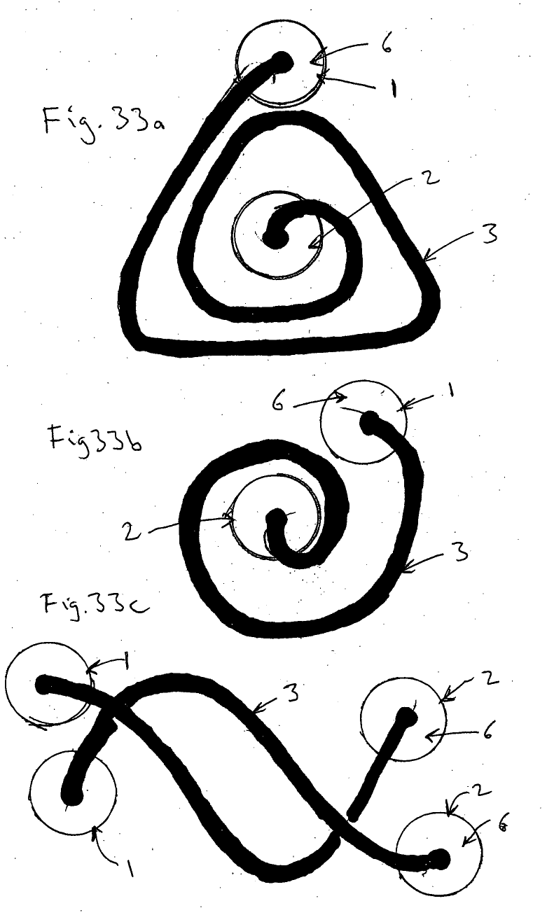

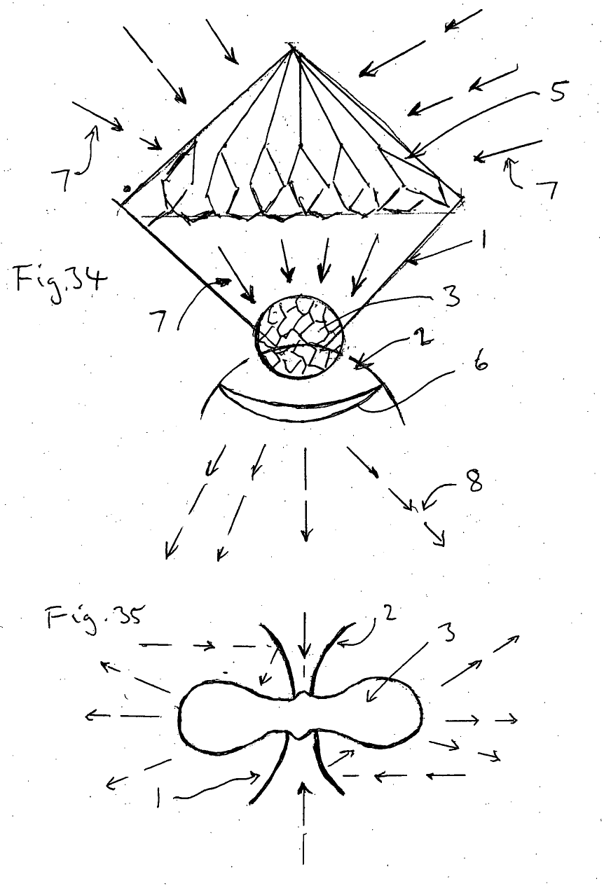

FIG. 30 Is a front view of FIG. 29, and shows how light rays 7 emanate from diodes 12 and are conveyed to the reflectors 1 and 2a's hind region delivering collimated and divergent rays of light in a concentrated way to a section of the luminescent material 3.

FIG. 31. Shows a side view of a versatile reflector ornament hovering above a levitator. The levitator uses electromagnetism to stabilise and assist in levitating the ornament's magnet.

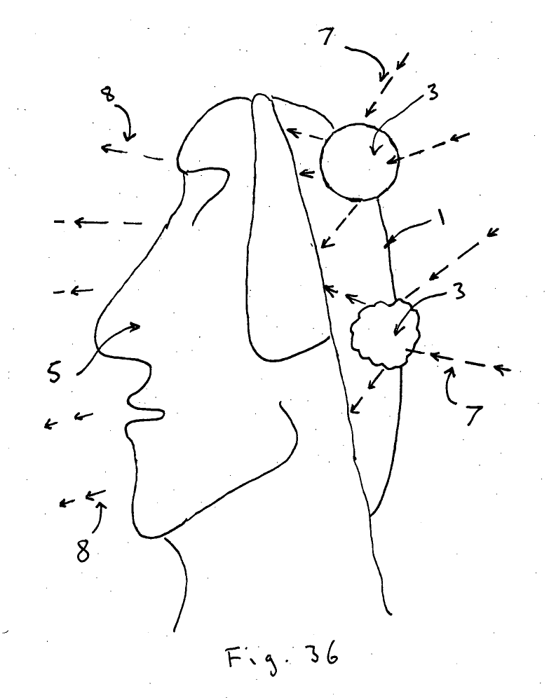

FIG. 32. Shows a perspective view of a magic money bank. Existing boxes are divided by a diagonal mirror giving the impression that half of the box actually appears to be a whole cube when in fact it is only a reflecting image adjoining half of the real image. This trick may be modified by having two plane mirror reflectors 1 and 2 on either side and inserting luminescent material 3 in a suitable shape through one or more apertures adjoining both sides. Luminescent material 3 in the shape of an object or figure will glow when it is excited by radiant light 7 received from either side and act as a light source for a viewer as well as deliver a spectacular trick, namely that the object will appear to be longer or bigger than what it actually is. As an ornament one could have figures for example dolphins positioned half way through mirrors 1 and 2 appearing to jump through the reflective surface. Lining one compartment partially with silver will create a V-shaped trough light collector, indirectly providing a brighter glow to its' partitioned neighbour.

FIGS. 33a, b and c show design samples of ornaments made of spiral shaped luminescent material, where each end is provided with reflectors and lenses or prisms. Spiral shapes increase the surface area within a certain space and are ideal for receiving light to energise photons within its material, providing light to the reflectors. The reflectors in turn concentrate light onto the end tips and further promote photon activity.

FIG. 33a shows a pyramid which may be further modified by adding an eye or other refracting body to the reflectors.

FIG. 33b depicts a circular shape and can be further modified by adding special gemstones to one or both reflectors.

FIG. 33c illustrates a three dimensional double helix spiral ornament, with reflectors lenses and prisms.

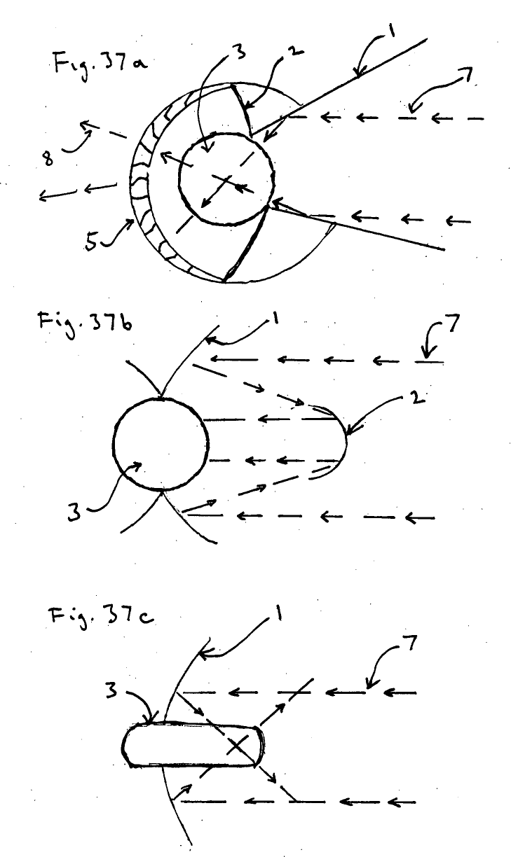

FIG. 34. Shows a side view of a special arrangement where a large reflector 1 is intended to collect sunlight through a light collecting prism able to concentrate light onto a multifaceted luminescent body 3, and thereby deliver light to a smaller reflector 2, provided with prismatic lens 6. This ornament will act as a novelty street lamp or decorative garden item.

FIG. 35 Shows a side view of luminescent material 3, resembling light bulbs appearing from either side of reflector 1 and 2. Light is received and transmitted from either side of the reflectors as well as in-between them. Modified versions may allow each reflector and bulb to work independently

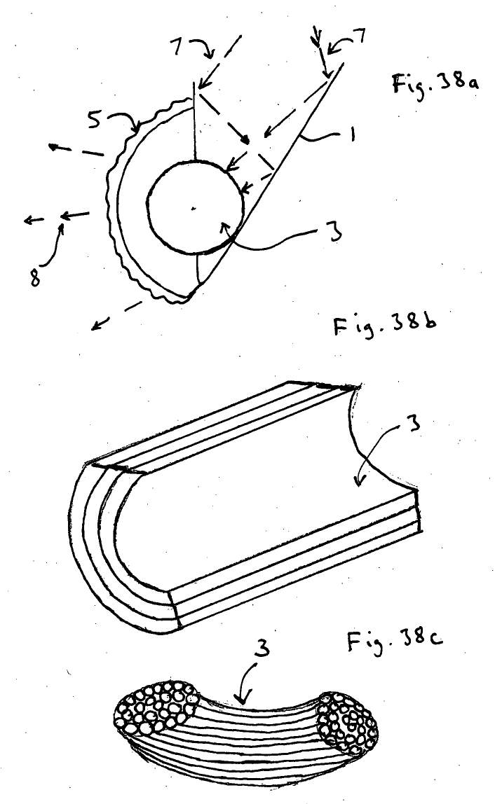

FIG. 36 Shows a cross sectional side view a translucent ornamental figure acting as a prism and lens 5, receiving light from one symmetrical and one asymmetrical luminescent body 3, mounted in apertures of a oblong reflector 1. Each body 3 receives light rays 7 from external sources. Luminescent light rays emanating from bodies 3, change wavelength as they refract through prism 5, and appear as visible light 8.

FIG. 37a Shows a cross section of a light guiding reflector. Light rays 7, enter reflector 1's large aperture and are internally reflected in order to concentrate rays onto luminescent material 3, mounted between reflector 1 and 2. Light is further refracted through prismatic lens 5, issuing as rays 8.

FIG. 37b Shows a cross section of a light concentrating parabolic reflector 1, reflecting onto an opposing reflector 2, able to redirect collimated or other rays onto a luminescent body 3.

FIG. 37c Shows a fluorescent or luminescent body 3, positioned within parabolic

1. A versatile reflector light system able to utilize ambient light or other remote energy sources, to increase illumination in a decorative and useful manner, by exciting or stimulating photons and electrons contained within light receiving/conducting/transmitting body member 3, at least partly internally mounted within a reflector 1 able to receive and transmit light and other energy anteriorly and posteriorly.

2. A versatile reflector light system according to claim 1, wherein a rear adjoining reflector 2, is configured to collect and guide concentrated light onto light receiving/conducting/transmitting body member 3, in order to promote excitation of electrons and photons.

3. A versatile reflector light system according to claims 1-3, wherein said light receiving/conducting/transmitting body member exhibits fluorescent and/or luminescent properties.

4. A versatile reflector light system according to claims 1-3, in which convex surfaces face one another, and are united through centrally placed apertures through which light receiving/conducting/transmitting body member is mounted, in order to receive incoming light from either reflector's concave reflective surface as well as between the circular furrow or gap created between the two convex reflective surfaces.

5. A versatile reflector light system according to claims 1-4, in which light receiving/conducting/transmitting body member is provided with a plurality of lenses or prisms in its vicinity and/or that the reflector has been provided with a lens or prismatic face covering cap.

6. A versatile reflector light system according to claim 1, in which pyramidal or conical reflectors in circular formation embrace a convex surface of a main reflector, so as to receive, internally reflect and guide light rays to a centrally placed aperture housing a light conducting/receiving/emitting body member.

7. A versatile reflector light system composed of pyramidal or conical reflectors, mounted in circular formation, each comprising highly internally reflecting surfaces, capable of collecting light from their base or large aperture, and reflecting and guiding light rays to their smaller tapered apical apertures, in order to illuminate light receiving/conducting/transmitting body member set in a central position in relation to the reflectors.

8. A versatile reflector light system as in claims 1-8, in which one or more magnets are housed or affixed in order to engage with external magnetic forces, and so provide movement of the ornamental object or levitation to reduce friction and improve motility.

9. A versatile reflector light system as in claims 1-9, in which one or more diode lamps accompany said light system, including a secondary coil, rectifier and condenser, and that energy is provided by inductive means from a primary coil situated some distance away.

10. A versatile light system having reflector and/or lens surfaces made of Fresnel, hologram, laser engraved or other suitable types

11. A versatile reflector light system having light receiving/conducting/transmitting body member made of glass, silicon, plastic, synthetic, biological, hybrid, fluorescing hydrogel, vaseline/uranium glass, electro-luminescent, luminescent eg. Coumarin or other excitable material and may contain traces of depleted uranium and plutonium and/or fluorescent material, of organic or inorganic origin.

12. A versatile reflector light system housing an internally mounted pressurized light receiving/conducting/transmitting body member having material able to emit electromagnetic radiation when subjected to incident radiation electrons, or other particles; exhibiting properties of absorbing light of short or invisible wavelength and emitting light of longer or visible wavelength

13. A versatile reflector light system housing an internally mounted light receiving/conducting/transmitting body member containing fluorescent material within a vacuum or among noble gases.

14. A versatile reflector light system composed of one or more oblong reflectors, when assembled together may form parallel oblong reflecting troughs between their opposing surfaces and this gap may in itself act as a reflector or light guide, interchanging rays between light receiving/conducting/transmitting material.

15. A versatile reflector light system utilising induction by transferring energy remotely from a primary coil to a secondary coil in order to activate and excite photons contained within electro-luminescent material.

16. A versatile reflector light system in which the fluorescent body member may be in solid, liquid, gel or gas form, and may be charged and excited by distantly placed energy sources such as ultra violet light, laser, infrared, microwaves and all other types of electromagnetic radiation and electromotive forces.

17. A versatile reflector light system covered by a polarizing crystal layer able to respond to small current changes actuated by small solar powered voltaic cells or a secondary coil receiving energy from a distant primary coil.

18. A versatile reflector light system housing an internally or partly internally mounted light receiving/conducting/transmitting body member in any aperture along the reflective walls or converging end.
